(19) United States
(12) Patent Application Publication
(10) Pub. No.: US 2013/0100460 A1
(43) Pub. Date: Apr. 25, 2013

(54) APPARATUS FOR MEASURING WARPAGE CHARACTERISTIC OF SPECIMEN

(71) Applicants: Seung Wan WOO, Suwon (KR); Suk Jin Ham, Seoul (KR); Kum Young Ji, Hwaseong (KR); Chae Hyun Na, Suwon (KR); Chang Yun Lee, Hwaseong (KR)

(72) Inventors: Seung Wan WOO, Suwon (KR); Suk Jin Ham, Seoul (KR); Kum Young Ji, Hwaseong (KR); Chae Hyun Na, Suwon (KR); Chang Yun Lee, Hwaseong (KR)

(73) Assignee: SAMSUNG ELECTRO-MECHANICS CO.,LTD.

(21) Appl. No.: 13/411,286

(22) Filed: Mar. 2, 2012

(30) Foreign Application Priority Data
Oct. 25, 2011 (KR) 10-2011-0109187

(51) Int. Cl. G01B 11/25

(52) U.S. Cl. 356/610

(57) ABSTRACT

There is provided an apparatus for measuring a warpage characteristic of a specimen, the apparatus including: a light irradiating unit irradiating light toward the specimen; alight transmitting member transmitting the light irradiated by the light irradiating unit therethrough and including a reference lattice pattern to allow a shadow to be formed on the specimen; a sensing unit sensing the shadow formed on the specimen by the reference lattice pattern; and a heating plate disposed under the light transmitting member and heating the specimen mounted thereon, wherein the reference lattice pattern formed on the light transmitting member is formed of a conductive material and is connected to a power supplying unit to thereby generate heat when power is supplied.

### CROSS-REFERENCE TO RELATED APPLICATIONS

This application claims the priority of Korean Patent Application No. 10-2011-0109187 filed on Oct. 25, 2011, in the Korean Intellectual Property Office, the disclosure of which is incorporated herein by reference.

### BACKGROUND OF THE INVENTION

1. Field of the Invention

The present invention relates to an apparatus for measuring a warpage characteristic of a specimen.

2. Description of the Related Art

In accordance with the recent trend toward miniaturization and lightness of an electronic product, a warpage deformation characteristic of an element of the electronic product or a complete product (for example, a substrate) has become important. That is, the element or the complete product may be exposed to a high temperature environment during a manufacturing process or during the use thereof, such that warpage deformation occurs in the element, the complete product, or the like.

As a result, warpage of the element, the complete product, or the like, in other words, warpage deformation characteristics thereof, are important pre-evaluation elements of an electronic product.

Therefore, various methods and apparatuses for measuring the warpage deformation characteristics have been developed and research into a method and an apparatus for measuring warpage deformation characteristics has been actively undertaken.

In addition, heat needs to be applied to the element or the complete product in order to measure the warpage deformation characteristics thereof (for example, the substrate). As methods of applying heat, a radiation method, a convection method, a conduction method, and the like have been used.

Among these methods, the conduction method is generally used to apply the heat to the element and the complete product, since it is important to rapidly raise and lower a temperature, that is, to rapidly heat and cool the element or the complete product in order to measure warpage deformation characteristics.

However, in the case of a heat transfer by conduction, a heat transfer rate is changed according a heat application contact area. Therefore, in the case of the conduction method, heat may not be uniformly transferred to the element or the complete product at the time of warpage deformation thereof.

That is, the development of technology for uniformly transferring heat to the entire element or complete product, even at the time of warpage deformation of the element or the complete product, has been demanded.

### SUMMARY OF THE INVENTION

An aspect of the present invention provides an apparatus for measuring a warpage characteristic of a specimen capable of uniformly transferring heat to the entire specimen.

According to an aspect of the present invention, there is provided an apparatus for measuring a warpage characteristic of a specimen, the apparatus including: a light irradiating unit irradiating light toward the specimen; a light transmitting member transmitting the light irradiated by the light irradiating unit therethrough and including a reference lattice pattern to allow a shadow to be formed on the specimen; a sensing unit sensing the shadow formed on the specimen by the reference lattice pattern; and a heating plate disposed under the light transmitting member and heating the specimen mounted thereon, wherein the reference lattice pattern formed on the light transmitting member is formed of a conductive material and is connected to a power supplying unit to thereby generate heat when power is supplied.

The apparatus may further include an enclosing member closing a space between the light transmitting member and the heating plate.

The enclosing member may be formed of a bellows having one end connected to an ascending and descending frame on which the light transmitting member is mounted and the other end connected to the heating plate to thereby allow the ascending and descending frame to ascend and descend.

A sealing member may be interposed between the enclosing member and the ascending and descending frame, and between the enclosing member and heating plate.

The reference lattice pattern may be formed of a metallic material in order to generate heat when power is supplied.

The sensing unit may include a light receiving member receiving light reflected from the specimen and including a camera or a charge coupled device (CCD) sensor.

The sensing unit may further include a lens member allowing the light reflected from the specimen to be received by the light receiving member.

The power supplying unit connected to the reference lattice pattern may further include a controlling unit allowing power to be supplied to the reference lattice pattern at the time of irradiation of light from the light irradiating unit.

The controlling unit may be connected to a driving unit allowing the ascending and descending frame to ascend and descend, to thereby control a distance between the light transmitting member and the specimen according to the specimen.

The light transmitting member may be formed of quartz so that the light irradiated from the light irradiating unit is transmitted therethrough.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a view schematically showing a configuration of an apparatus for measuring a warpage characteristic of a specimen according to an embodiment of the present invention;

FIG. 2 is a view schematically showing a configuration of a light transmitting member provided in the apparatus for measuring a warpage characteristic of a specimen according to the embodiment of the present invention;

FIG. 3 is a view describing an operation of the apparatus for measuring a warpage characteristic of a specimen according to the embodiment of the present invention;

FIG. 4 is a view schematically showing a configuration of an apparatus for measuring a warpage characteristic of a specimen according to another embodiment of the present invention;

FIG. 5 is a view describing an operation of the apparatus for measuring a warpage characteristic of a specimen according to another embodiment of the present invention;

FIG. 6 is a view schematically showing a configuration of an apparatus for measuring a warpage characteristic of a specimen according to another embodiment of the present invention; and

FIGS. 7 and 8 are views each describing an operation of the apparatus for measuring a warpage characteristic of a specimen according to another embodiment of the present invention.

### DETAILED DESCRIPTION OF THE PREFERRED EMBODIMENT

Embodiments of the present invention will now be described in detail with reference to the accompanying drawings. However, it should be noted that the spirit of the present invention is not limited to the embodiments set forth herein and those skilled in the art and understanding the present invention could easily accomplish retrogressive inventions or other embodiments included in the spirit of the present invention by the addition, modification, and removal of components within the same spirit, but those are to be construed as being included in the spirit of the present invention.

Further, when it is determined that the detailed description of the known art related to the present invention may obscure the gist of the present invention, a detailed description thereof will be omitted.

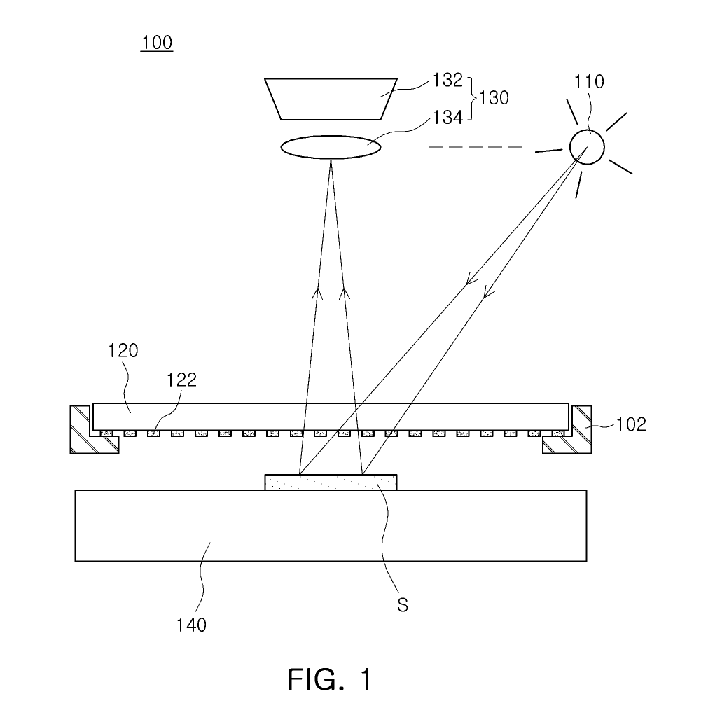

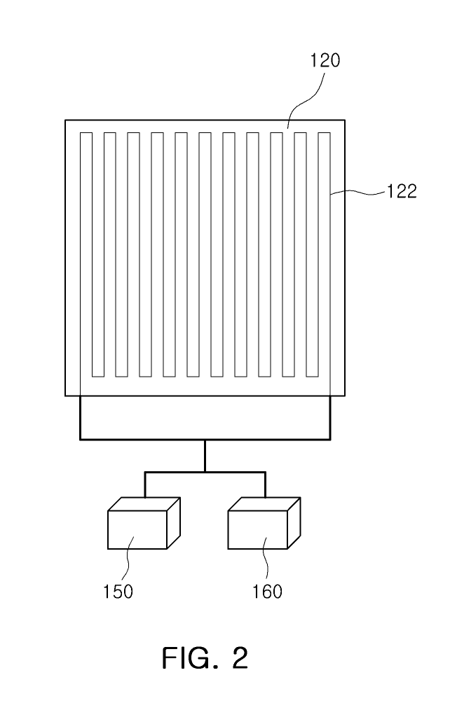

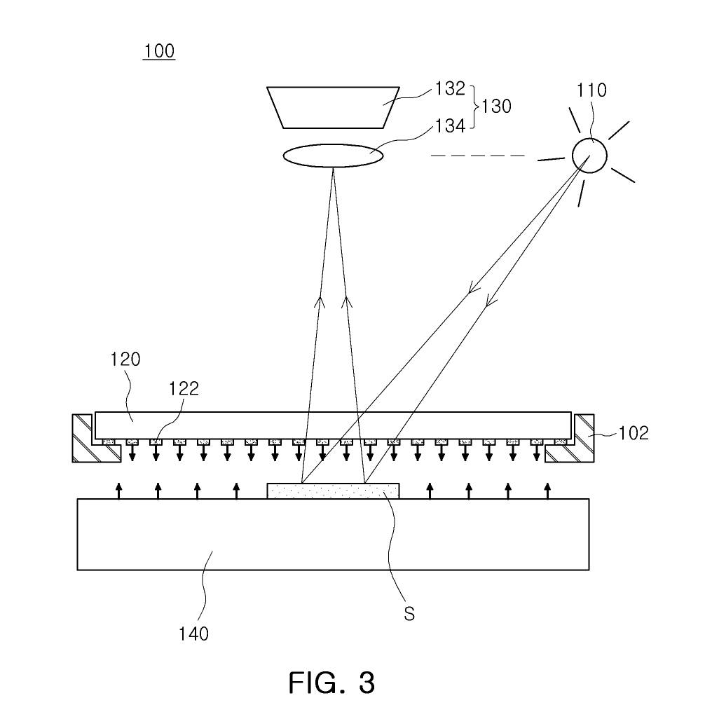

FIG. 1 is a view schematically showing a configuration of an apparatus for measuring a warpage characteristic of a specimen according to an embodiment of the present invention. FIG. 2 is a view schematically showing a configuration of a light transmitting member provided in the apparatus for measuring a warpage characteristic of a specimen according to the embodiment of the present invention. FIG. 3 is a view describing an operation of the apparatus for measuring a warpage characteristic of a specimen according to the embodiment of the present invention.

Referring to FIGS. 1 through 3, an apparatus 100 for measuring a warpage characteristic of a specimen according to the embodiment of the present invention may include a light irradiating unit 110, a light transmitting member 120, a sensing unit 130, and a heating plate 140, by way of example.

The light irradiating unit 110 may irradiate light toward a specimen S mounted on the heating plate 140. To this end, the light irradiating unit 110 may include a light source disposed to be spaced apart from the heating plate 140. Meanwhile, the light source maybe a white light source so that a shadow formed on the specimen may be more clearly identified.

However, the light source is not limited to the white light source, and may be any light source capable of emitting light that may be irradiated on the specimen S and sensed by the sensing unit 130. The light source may emit, for example, ultraviolet light, infrared light, laser light, or the like.

Meanwhile, the light transmitting member 120 may be disposed above the heating plate 140. In addition, the light transmitting member 120 may be formed of a material through which light irradiated by the light irradiating unit 110 may be transmitted, for example, quartz. The light transmitting member 120 may include a reference lattice pattern 122 in order that the shadow may be formed on the specimen S.

Meanwhile, the reference lattice pattern 122 may be formed on a lower surface of the light transmitting member 120 so as to be disposed to face the specimen S mounted on the heating plate 140.

In addition, the reference lattice pattern 122 formed on the lower surface of the light transmitting member 120 may be formed of a conductive material. Further, the reference lattice pattern 122 may be connected to a power supplying unit 150 to generate heat when power is supplied.

Therefore, heat is transferred from a heat source other than the heating plate 140 to the specimen S mounted on the heating plate 140, such that heat may be more rapidly transferred to the specimen S. Further, in the case in which warpage occurs in the specimen S, heat generated from the heating plate 140 is non-uniformly transferred to the specimen S. However, the heat may be more uniformly transferred to the specimen S by the heat supplied from the reference lattice pattern 122.

As a result, the heat transferred to the specimen S may be more uniformly transferred to the entire area of the specimen S, a warpage characteristic of the specimen S may be more accurately measured.

Meanwhile, the reference lattice pattern 122 may be formed of a metallic material such as copper (Cu), an alloy of nickel and chrome, or the like. Therefore, when power is supplied to the reference lattice pattern 122, heat is generated therefrom, such that the specimen S may be heated.

In addition, the reference lattice pattern 122 may be formed by deposition of copper or an alloy of nickel and chrome through sputtering by way of example.

Meanwhile, the reference lattice pattern 122 is not limited to being formed of the above metallic material but may be formed of any material capable of generating heat by supplied power. That is, the reference lattice pattern 122 may also be formed of a non-metallic material capable of generating heat by supplied power.

In addition, a material for the reference lattice pattern 122 is not limited to a material such as copper, an alloy of nickel and chrome, or the like.

Meanwhile, a shape of the reference lattice pattern 122 is shown in FIG. 2, by way of example. However, the shape of the reference lattice pattern 122 is not limited to being shown in FIG. 2 but may be changed into various shapes such as a lattice shape, a circular shape, or the like.

The light transmitting member 120 may be fixedly mounted on a fixed frame 102. The fixed frame 102 may have a frame shape in which an upper portion thereof is opened such that the light transmitting member 120 may be mounted thereon.

That is, the light transmitting member 120 may be mounted on the fixed frame 102 and disposed above the heating plate 140.

The sensing unit 130 may sense the shadow formed on the specimen S by the reference lattice pattern 122. To this end, the sensing unit 130 may be disposed above the specimen S mounted on the heating plate 140.

Meanwhile, the sensing unit 130 may include a light receiving member 132 receiving light reflected from the specimen S. The light receiving member 132 may be configured to include a camera or a charge coupled device (CCD) sensor, by way of example . That is, the light irradiated from the light irradiating unit 110 may pass through the light transmitting member 120 to arrive at the specimen S. At this time, the shadow may be formed on the specimen S by the reference lattice pattern 122.

Then, the light arriving at the specimen S may be reflected to be received by the light receiving member 132 of the sensing unit 130. Meanwhile, the specimen S may be deformed by the heat generated from the heating plate 140 and the reference lattice pattern 122. Due to this deformation of the specimen S, the light sensed by the light receiving member 132 of the sensing unit 130 may be different from that of the case in which the specimen S is not deformed.

That is, a shape of the shadow formed on the specimen S by the reference lattice pattern 122 may be different from that of the shadow in the case in which the specimen S is not deformed.

As described above, a warpage characteristic of the specimen S may be observed by the shape of the shadow on the specimen S sensed by the sensing unit 130.

In addition, the sensing unit 130 may include a lens member 134 allowing the light reflected from the specimen S to be received by the light receiving member 132 . The lens member 134 may be disposed in front of the light receiving member 132 in a light path, and allow the light reflected from the specimen S to be received by the light receiving member 132 therethrough, thereby making a sensed image more clear.

Therefore, the deformation of the specimen S, that is, the warpage characteristic of the specimen S may be more precisely measured.

The heating plate 140 may be disposed under the light transmitting member 120 and serve to heat the specimen S mounted thereon. That is, the heating plate 140 may be disposed to be spaced apart from the light transmitting member 120 by a predetermined interval and may include the specimen S mounted on an upper surface thereof. In addition, the heating plate 140 may heat the specimen S mounted on the upper surface thereof.

The heating plate 140 may heat the specimen S to a predetermined temperature (for example, 260 to 300° C.) to thereby allow the warpage characteristic of the specimen S to be measured. That is, the heating plate 140 may heat the specimen S to a predetermined temperature to thereby deform the specimen S.

Meanwhile, the specimen S mounted on the heating plate 140 maybe a substrate. However, when the specimen S is deformed due to heating by the heating plate 140, a heat transfer rate of heat transferred to the specimen S may be changed.

In order to alleviate this defect, power is supplied to the reference lattice pattern 122 when the specimen S is heated by the heating plate 140, thereby allowing heat to be generated from the reference lattice pattern 122.

Meanwhile, the reference lattice pattern 122 may be connected to the power supplying unit 150, and the power supplying unit 150 may be connected to a controlling unit 160 allowing power to be supplied to the reference lattice pattern 122 when light is irradiated from the light irradiating unit 110, as shown in FIG. 2.

That is, the apparatus 100 for measuring a warpage characteristic of a specimen according to the embodiment of the present invention may further include the controlling unit 160 connected to the power supplying unit 150 to thereby control current supplied to the reference lattice pattern 122.

That is, the controlling unit 160 may control the power supplying unit 150 to allow the reference lattice pattern 122 to heat the specimen S together with the heating plate 140 or to allow the reference lattice pattern 122 to heat the specimen S after the heating plate 140 has heated the specimen S (in other words, when deformation occurs in the specimen).

Therefore, a phenomenon in which only a portion of the specimen S is locally heated may be reduced.

As described above, since the specimen S may be heated through both of the heating plate 140 and the reference lattice pattern 122 connected to the power supplying unit 150, heat may be uniformly transferred to the entire specimen S.

Therefore, the warpage characteristic of the specimen S may be more precisely measured.

Hereinafter, an apparatus for measuring a warpage characteristic of a specimen according to another embodiment of the present invention will be described, with reference to the accompanying drawings.

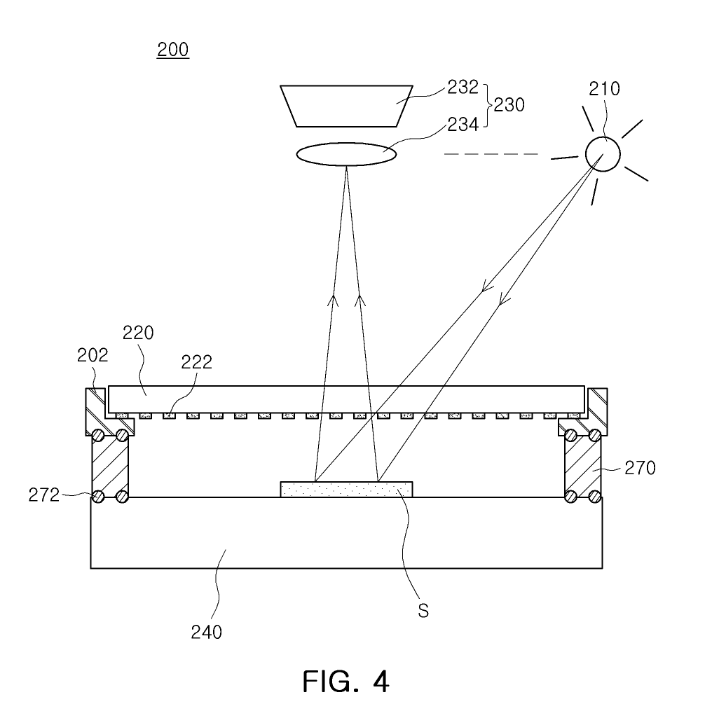

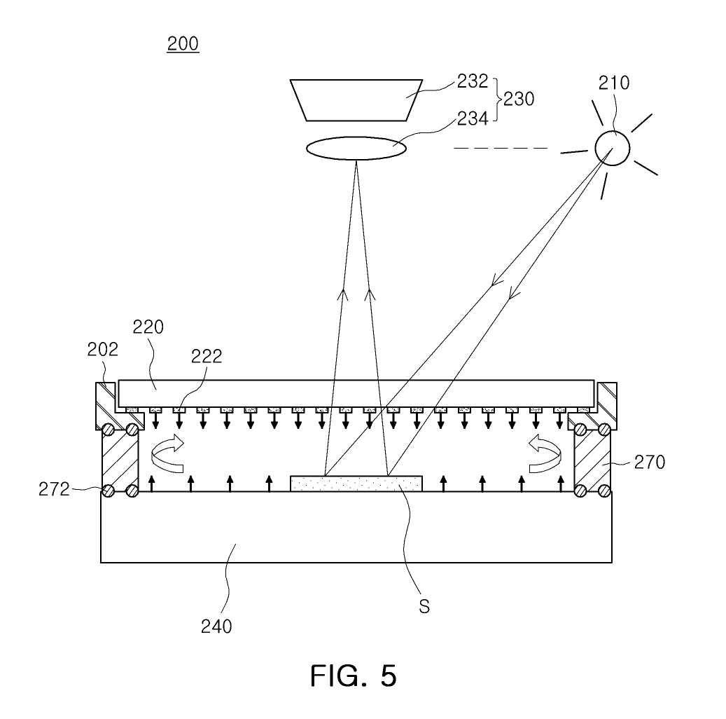

FIG. 4 is a view schematically showing a configuration of an apparatus for measuring a warpage characteristic of a specimen according to another embodiment of the present invention. FIG. 5 is a view describing an operation of the apparatus for measuring a warpage characteristic of a specimen according to another embodiment of the present invention.

Referring to FIGS. 4 and 5, an apparatus 200 for measuring a warpage characteristic of a specimen according to another embodiment of the present invention may include a light irradiating unit 210, a light transmitting member 220, a sensing unit 230, a heating plate 240, and an enclosing member 270, by way of example.

Meanwhile, the light irradiating unit 210, the light transmitting member 220, the sensing unit 230, and the heating plate 240 are the same as the light irradiating unit 110, the light transmitting member 120, the sensing unit 130, and the heating plate 140, respectively, included in the apparatus 100 for measuring a warpage characteristic of a specimen according to the foregoing embodiment of the present invention. Therefore, a detailed description thereof will be omitted and be replaced by the above-mentioned description.

Hereinafter, only components different from the components included in the apparatus 100 for measuring a warpage characteristic of a specimen according to the foregoing embodiment of the present invention will be described.

First, the light transmitting member 220 may be fixedly mounted on a fixed frame 202. The fixed frame 202 may have a frame shape in which an upper portion thereof is opened such that the light transmitting member 220 may be mounted thereon.

That is, the light transmitting member 220 may be mounted on the fixed frame 202 and disposed above the heating plate 240.

In addition, the light transmitting member 220 may include a reference lattice pattern 222 to allow a shadow to be formed on the specimen S by light irradiated from the light irradiating unit 210. Further, the reference lattice pattern 222 may be provided on a lower surface of the light transmitting member 220 and be connected to the power supplying unit 150 (See FIG. 2) to thereby serve to heat the specimen S mounted on the heating plate 240.

Meanwhile, the apparatus 200 for measuring a warpage characteristic of a specimen according to another embodiment of the present invention may further include the enclosing member 270 closing a space between the light transmitting member 220 and the heating plate 240.

The enclosing member 270 may serve to close the space formed by the light transmitting member 220 and the heating plate 240 to thereby reduce heat loss.

Therefore, in the case in which the specimen S is heated by the heating plate 240, a phenomenon in which the heat generated from the heating plate 240 is leaked from the space formed by the light transmitting member 220 and the heating plate 240 to the outside may be reduced.

As a result, the space formed by the light transmitting member 220 and the heating plate 240 is closed by the enclosing member 270, whereby heat transfer efficiency to the specimen S may be improved and the heat may be more uniformly transferred to the specimen S.

Meanwhile, the enclosing member 270 may have one end connected to the fixed frame 202 and the other end connected to the heating plate 240. In addition, the fixed frame 202 and one end of the enclosing member 270 and/or the heating plate 240 and the other end of the enclosing member 270 may have a plurality of sealing members 272 installed therebetween.

Therefore, the heat leaked from a closed space (a space formed by the light transmitting member 220, the heating plate 240, and the enclosing member 270) to the outside is further reduced, whereby heat may be more uniformly transferred to the specimen S.

Meanwhile, each sealing member 272 may be an O-ring and may be formed of an elastic material. That is, the sealing member 272 is not limited to the O-ring but may be any component capable of being formed of an elastic material to thereby reduce heat transfer from the closed space to the outside.

As described above, heat is transferred to the specimen S through the reference lattice pattern 222 formed on the lower surface of the light transmitting member 220 and formed of a conductive material, whereby the heat may be uniformly transferred to the entire specimen S.

In addition, the space formed by the heating plate 240 having the specimen S mounted thereon and the light transmitting member 220 is closed by the enclosing member 270 to allow heat to be uniformly transferred to the specimen S, whereby the warpage characteristic of the specimen S may be more precisely measured.

Hereinafter, an apparatus for measuring a warpage characteristic of a specimen according to another embodiment of the present invention will be described with reference to the accompanying drawings.

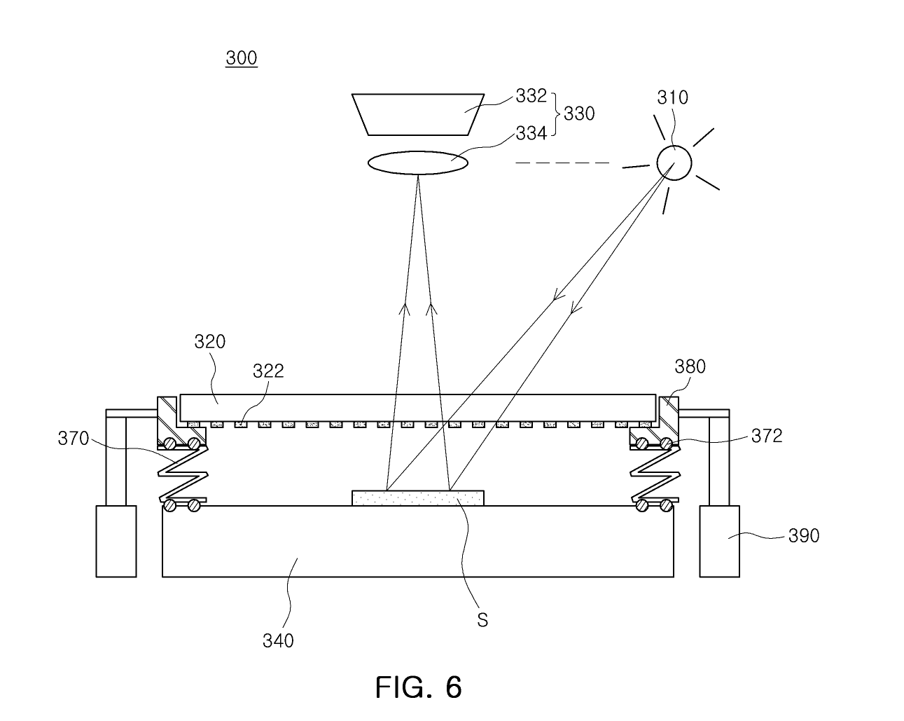

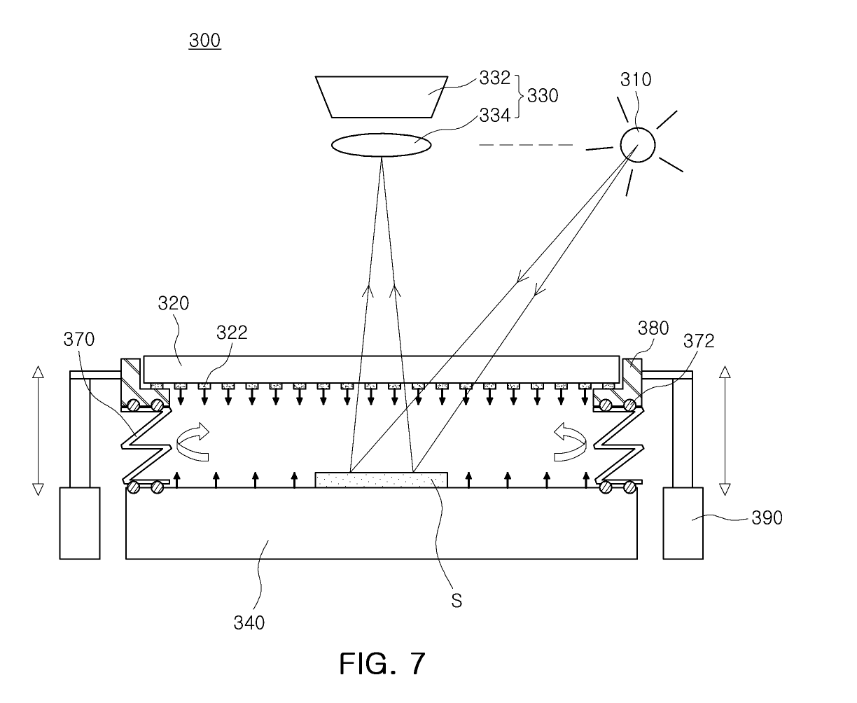

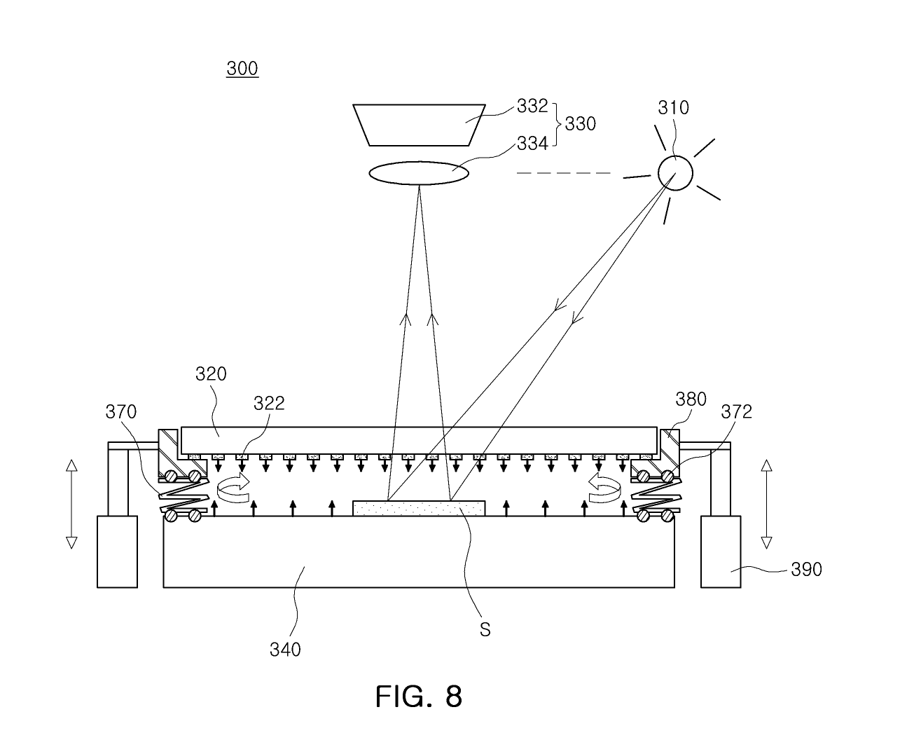

FIG. 6 is a view schematically showing a configuration of an apparatus for measuring a warpage characteristic of a specimen according to another embodiment of the present invention. FIGS. 7 and 8 are views each describing an operation of the apparatus for measuring a warpage characteristic of a specimen according to another embodiment of the present invention.

Referring to FIGS. 6 through 8, an apparatus 300 for measuring a warpage characteristic of a specimen according to the embodiment of the present invention may include a light irradiating unit 310, a light transmitting member 320, a sensing unit 330, a heating plate 340, and a enclosing member 370, by way of example.

Meanwhile, the light irradiating unit 310, the light transmitting member 320, the sensing unit 330, and the heating plate 340 are the same as the light irradiating unit 110, the light transmitting member 120, the sensing unit 130, and the heating plate 140, respectively, which are included in the apparatus 100 for measuring a warpage characteristic of a specimen according to the foregoing embodiment of the present invention. Therefore, a detailed description thereof will be omitted and replaced by the above-mentioned description.

The light transmitting member 320 may be fixedly mounted on an ascending and descending frame 380. The ascending and descending frame 380 may have a frame shape in which an upper portion thereof is opened such that the light transmitting member 320 may be mounted thereon.

That is, the light transmitting member 320 may be mounted on the ascending and descending frame 380 and disposed so as to ascend and descend over the heating plate 240.

Meanwhile, the ascending and descending frame 380 may be connected to a driving unit 390 to thereby ascend and descend. That is, in order to improve a yield of light reflected from the specimen S to the sensing unit 330, the light transmitting member 320 and the heating plate 340 need to be spaced apart from each other by a predetermined distance.

However, the distance between the light transmitting member 320 and the heating plate 340 needs to be changed according to a warpage degree of the specimen S and/or a thickness of the specimen S. To this end, the ascending and descending frame 380 may be connected to the driving unit 390 to thereby ascend and descend in such a manner that the distance between the light transmitting member 320 and the heating plate 340 may be changed.

The driving unit 390 may include a plurality of cylinder members in order to allow the ascending and descending frame 380 to ascend and descend and, the driving unit 390 may be connected to the controlling unit (not shown) to control the distance between the light transmitting member 320 and the heating plate 340.

Meanwhile, the light transmitting member 320 may include a reference lattice pattern 322 to allow a shadow to be formed on the specimen S by light irradiated from the light irradiating unit 310. Further, the reference lattice pattern 322 may be provided on a lower surface of the light transmitting member 320 and be connected to the power supplying unit 150 (See FIG. 2) to thereby serve to heat the specimen S mounted on the heating plate 340.

Meanwhile, the apparatus 300 for measuring a warpage characteristic of a specimen according to another embodiment of the present invention may further include the enclosing member 370 closing a space between the light transmitting member 320 and the heating plate 340.

The enclosing member 370 may serve to close the space formed by the light transmitting member 320 and the heating plate 340 to thereby reduce heat loss.

Therefore, in the case in which the specimen S is heated by the heating plate 340, a phenomenon in which the heat generated from the heating plate 340 is leaked from the space formed by the light transmitting member 320 and the heating plate 340 to the outside may be reduced.

As a result, the space formed by the light transmitting member 320 and the heating plate 340 is closed by the enclosing member 370, whereby heat transfer efficiency to the specimen S may be improved and the heat may be more uniformly transferred to the specimen S.

Meanwhile, the enclosing member 370 may have one end connected to the ascending and descending frame 380 and the other end connected to the heating plate 340. In addition, the ascending and descending frame 380 and one end of the enclosing member 370 and/or the heating plate 340 and the other end of the enclosing member 370 may have a plurality of sealing members 372 installed therebetween.

Therefore, heat leaked from a closed space (a space formed by the light transmitting member 320, the heating plate 340, and the enclosing member 370) to the outside is further reduced, whereby heat may be more uniformly transferred to the specimen S.

That is, the heat loss is further reduced by the sealing members 372, whereby a temperature deviation between the respective points of the closed space may be further reduced. Therefore, heat may be more uniformly transferred to the specimen S.

In addition, the enclosing member 370 may be formed of a bellows having one end connected to the ascending and descending frame 380 on which the light transmitting member 320 is mounted and the other end connected to the heating plate 340 to thereby allow the ascending and descending frame 380 to ascend and descend.

Therefore, the space formed by the light transmitting member 320, the heating plate 340, and the enclosing member 370 may also be closed by the ascending and descending of the ascending and descending frame 380.

As a result, a disposition space of the specimen S may be maintained at a predetermined temperature by the enclosing member 370. That is, the entire specimen S may be constantly heated.

Meanwhile, each sealing member 372 may be an O-ring and may be formed of an elastic material. That is, the sealing member 372 is not limited to the O-ring but may be any component capable of being formed of an elastic material to thereby reduce heat transfer from the closed space to the outside.

As set forth above, according to the embodiments of the present invention, heat is transferred to the specimen S through the reference lattice pattern 322 formed on the lower surface of the light transmitting member 320 and formed of a conductive material, whereby the heat may be uniformly transferred to the entire specimen S.

In addition, the space formed by the heating plate 340 having the specimen S mounted thereon and the light transmitting member 320 is closed by the enclosing member 370 to allow heat to be uniformly transferred to the specimen S, whereby the warpage characteristic of the specimen may be more precisely measured.

While the present invention has been shown and described in connection with the embodiments, it will be apparent to those skilled in the art that modifications and variations can be made without departing from the spirit and scope of the invention as defined by the appended claims.

What is claimed is:

1. An apparatus for measuring a warpage characteristic of a specimen, the apparatus comprising:
a light irradiating unit irradiating light toward the specimen;
a light transmitting member transmitting the light irradiated by the light irradiating unit therethrough and including a reference lattice pattern to allow a shadow to be formed on the specimen;
a sensing unit sensing the shadow formed on the specimen by the reference lattice pattern; and
a heating plate disposed under the light transmitting member and heating the specimen mounted thereon,
wherein the reference lattice pattern formed on the light transmitting member is formed of a conductive material and is connected to a power supplying unit to thereby generate heat when power is supplied.

2. The apparatus of claim 1, further comprising an enclosing member closing a space between the light transmitting member and the heating plate.

3. The apparatus of claim 2, wherein the enclosing member is formed of a bellows having one end connected to an ascending and descending frame on which the light transmitting member is mounted and the other end connected to the heating plate to thereby allow the ascending and descending frame to ascend and descend.

4. The apparatus of claim 3, wherein a sealing member is interposed between the enclosing member and the ascending and descending frame, and between the enclosing member and heating plate.

5. The apparatus of claim 1, wherein the reference lattice pattern is formed of a metallic material in order to generate heat when power is supplied.

6. The apparatus of claim 1, wherein the sensing unit includes a light receiving member receiving light reflected from the specimen and including a camera or a charge coupled device (CCD) sensor.

7. The apparatus of claim 6, wherein the sensing unit further includes a lens member allowing the light reflected from the specimen to be received by the light receiving member.

8. The apparatus of claim 3, wherein the power supplying unit connected to the reference lattice pattern further includes a controlling unit allowing power to be supplied to the reference lattice pattern at the time of irradiation of light from the light irradiating unit.

9. The apparatus of claim 8, wherein the controlling unit is connected to a driving unit allowing the ascending and descending frame to ascend and descend, to thereby control a distance between the light transmitting member and the specimen according to the specimen.

10. The apparatus of claim 1, wherein the light transmitting member is formed of quartz such that the light irradiated from the light irradiating unit is transmitted therethrough.
